(19) United States
(12) Patent Application Publication
(10) Pub. No.: US 2018/0048387 A1
(43) Pub. Date: Feb. 15, 2018

(54) SIGNAL PROCESSING METHOD AND DEVICE, AND RECEIVER

(71) Applicant: ZTE CORPORATION, Guangdong (CN)

(72) Inventors: Baiqing ZONG, Guangdong (CN); Yong LI, Guangdong (CN)

(73) Assignee: ZTE CORPORATION, Guangdong (CN)

(21) Appl. No.: 15/554,029

(22) PCT Filed: Feb. 15, 2016
(86) PCT No.: PCT/CN2016/073798

§ 371 Date: Aug. 28, 2017

(30) Foreign Application Priority Data
Feb. 26, 2015 (CN) 201510088474.0
Apr. 21, 2015 (CN) 201510191656.0

(51) Int. Cl. H04B 10/112; H04J 11/00; H04L 27/26; H04B 10/114

(52) U.S. Cl. CPC H04B 10/112; H04B 10/114; H04J 11/0086; H04L 27/2602; H04L 27/2663; H04B 10/548

(57) ABSTRACT

Provided are a method and a device for processing signal, and a receiver. The method includes: receiving a signal to be recovered; determining a cutting position of the signal to be recovered; and recovering the signal to be recovered into a transmitted signal according to the determined clipping position.

### CROSS-REFERENCE TO RELATED APPLICATION

This application is the 371 application of PCT Application No. PCT/CN2016/073798, filed Feb. 15, 2016, which is based upon and claims priority to Chinese Patent Application No. 201510088474.0, filed Feb. 26, 2015, and Chinese Patent Application No. 201510191656.0, filed Apr. 21, 2015, the entire contents of which are incorporated herein by reference.

### TECHNICAL FIELD

The present disclosure relates to the field of communication, and more particularly, to a method for processing signal and device thereof and a receiver.

### BACKGROUND

Visible light wireless communication systems are facing some challenges. Low-pass characteristics presented by Light Emitting Diodes (LEDs) and dispersion characteristics of visible light wireless channels result in Inter-Symbol Interference (ISI) in high-speed visible light wireless communication. In order to confront the ISI, Orthogonal Frequency Division Multiplexing (OFDM) technology and single-carrier Pulse Amplitude Modulated based Frequency Domain Equalization (PAM-FDE) in the visible light wireless communication have got a lot of researches. Among OFDM/DMT-based technologies, the following three modulation technologies are the most mature: Direct Current-biased Optical-OFDM (DCO-OFDM), Asymmetrically Clipped-biased optical-OFDM (ACO-OFDM), and Pulse-Amplitude-Modulated Discrete MultiTone (PAM-DMT).

Under constraints by the Intensity Modulation/Direct Detection (IM/DD) (the transmitted signal has no polarity but only has strength), in the fight against multipath interference, DCO-OFDM, ACO-OFDM and PAM-DMT all sacrifice one aspect of performance to achieve another aspect of performance. In DCO-OFDM, power is sacrificed to achieve high-speed transmission of data. In ACO-OFDM, the number of modulated subcarriers is sacrificed to achieve the power effectiveness. In PAM-DMT, the dimension of modulation constellation is sacrificed to achieve power effectiveness. In order to meet the real and positive constraints of the time-domain signal, the ACO-OFDM carrier has Hermite symmetry, only the odd-subcarrier carries information, and the negative value data will be clipped off. The signal distortion caused by the clipping is called clipping noise, and the clipping noise is orthogonal to data, resulting in no loss of information carried on odd sub-carriers. Conventional ACO-OFDM receivers ignore the information on the even-subcarriers of the received signal and only use the information on the odd-subcarrier for demodulation. It can be seen that there is a problem in the related art that the performance of the receiver is worse.

Up to now, there is no effective solution to address the problem of worse performance of the receiver in the related art.

This section provides background information related to the present disclosure which is not necessarily prior art.

### SUMMARY

The present disclosure provides a method and device for processing signal and a receiver in order to solve at least the problem of worse performance of the receiver in the related art.

According to an aspect of the present disclosure, there is provided a method for processing signal, including: receiving a signal to be recovered; determining a clipping position of the signal to be recovered; and recovering the signal to be recovered into a transmitted signal according to the determined clipping position.

Optionally, the determining a clipping position of the signal to be recovered, includes: performing an analog-to-digital (AD) sampling on the received signal to be recovered to convert the received signal into a digital time-domain signal; and determining the clipping position of the signal to be recovered using a polarity of the digital time-domain signal.

Optionally, the determining the clipping position of the signal to be recovered using the polarity of the digital time-domain signal, includes: determining values of signals at corresponding symmetric positions of the digital time-domain signal; and determining the clipping position according to magnitudes of the values of the signals at the corresponding symmetric positions, wherein a position associated with a small value of the signal at the corresponding symmetric position corresponds to the clipping position.

Optionally, the recovering the signal to be recovered into a transmitted signal according to the determined clipping position, includes: recovering a signal at the clipping position using a counter cyclical symmetry of Asymmetrically Clipped-biased optical-OFDM (ACO-OFDM); converting the signal to be recovered in which the signal at the clipping position has been recovered into a frequency-domain signal using Fast Fourier Transform (FFT); and recovering the transmitted signal using the frequency-domain signal.

According to another aspect of the present disclosure, there is provided a device for processing signal, including: a receiving module configured to receive a signal to be recovered; a determination module configured to determine a clipping position of the signal to be recovered; and a recovery module configured to recover the signal to be recovered into a transmitted signal according to the determined clipping position.

Optionally, the determination module includes: a first conversion unit configured to perform an analog-to-digital (AD) sampling on the received signal to be recovered to convert the received signal into a digital time-domain signal; and a determination unit configured to determine the clipping position of the signal to be recovered using a polarity of the digital time-domain signal.

Optionally, the determination unit includes: a first determination sub-unit configured to determine values of signals at corresponding symmetric positions of the digital time-domain signal; and a second determination sub-unit configured to determine the clipping position according to magnitudes of the values of the signals at the corresponding symmetric positions, wherein a position associated with a small value of the signal at the corresponding symmetric position corresponds to the clipping position.

Optionally, the recovery module includes: a first recovery unit configured to recover the signal at the clipping position using a counter cyclical symmetry of Asymmetrically Clipped-biased optical-OFDM (ACO-OFDM); a second conversion unit configured to convert the signal to be recovered in which the signal at the clipping position has been recovered into a frequency-domain signal using Fast Fourier Transform (FFT); and a second recovery unit configured to recover the transmitted signal using the frequency-domain signal.

According to another aspect of the present disclosure, there is provided a receiver including the device as mentioned above.

In order to at least solve the above technical problems, the embodiments of the present disclosure also provide a computer storage medium, wherein the computer storage medium is stored with a computer-executable instruction, and the computer-executable instruction is configured to:

receive a signal to be recovered;

determine a cutting position of the signal to be recovered; and

recover the signal to be recovered into a transmitted signal according to the determined clipping position.

In the present disclosure, a signal to be recovered is received, a clipping position of the signal to be recovered is determined, and the signal to be recovered is recovered into a transmitted signal according to the determined clipping position. Thus, the problem of worse performance of the receiver in related can be addressed, and thereby the performance of the receiver can be improved.

This section provides a summary of various implementations or examples of the technology described in the disclosure, and is not a comprehensive disclosure of the full scope or all features of the disclosed technology.

### BRIEF DESCRIPTION OF THE DRAWINGS

The accompanying drawings, which constitute a part of this specification, facilitate understanding of the present disclosure, and the exemplary embodiments of the present disclosure and the descriptions thereof are used for explaining the present disclosure but not for unduly limiting the present disclosure. In the drawings:

FIG. 1 is a flow chart of a method for processing signal according to some embodiments of the present disclosure;

FIG. 2 is a block diagram showing a structure of a device for processing signal according to some embodiments of the present disclosure;

FIG. 3 is a block diagram showing a structure of a determination module 24 in the device for processing signal according to some embodiments of the present disclosure;

FIG. 4 is a block diagram showing a structure of a determination unit 34 in the device for processing signal according to some embodiments of the present disclosure;

FIG. 5 is a block diagram showing a structure of a recovery module 26 in the device for processing signal according to some embodiments of the present disclosure;

FIG. 6 is a block diagram showing a structure of a receiver according to some embodiments of the present disclosure;

FIG. 7 is a block diagram showing a structure of a system transmitting end according to some embodiments of the present disclosure;

FIG. 8 is a block diagram showing a structure of a system receiving end according to some embodiments of the present disclosure;

FIG. 9 is a graph showing BER (Bit Error Rate) simulation results of an enhanced ACO-OFDM according to some embodiments of the present disclosure;

FIG. 10 is a schematic diagram showing a frame structure according to some embodiments of the present disclosure;

FIG. 11 is a schematic diagram showing a convolutional encoder according to some embodiments of the present disclosure; and

FIG. 12 is a block diagram showing an enhanced ACO-OFDM transmitter and receiver according to some embodiments of the present disclosure.

### DETAILED DESCRIPTION

The present disclosure will be described in detail with reference to drawings in combination with embodiments. It should be noted that embodiments and features in the embodiments in the present disclosure can be combined if these embodiments and features do not conflict with each other.

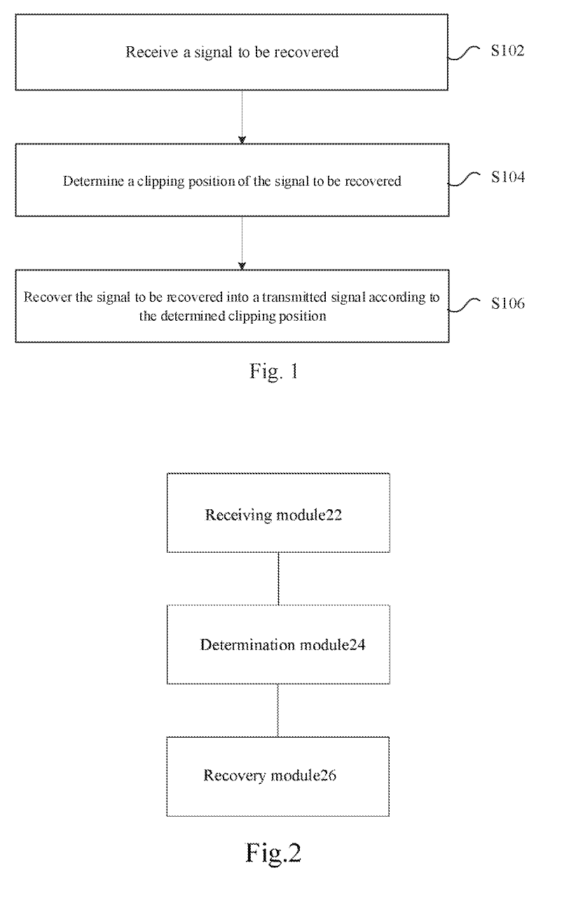

The present embodiment provides a method for processing signal. FIG. 1 is a flow chart of a method for processing signal according to some embodiments of the present disclosure. As shown in FIG. 1, the flow may include the following steps.

In step S102, a signal to be recovered is received.

In step S104, a clipping position of the signal to be recovered is determined.

In step S106, the signal to be recovered is recovered into a transmitted signal according to the determined clipping position.

By the above steps, the signal at the clipping position in the received signal to be recovered is recovered, and thus noise can be reduced and energy utilization ratio can be increased. Consequently, the problem of worse performance of the receiver in related art can be addressed, thereby improving the performance of the receiver.

There are many approaches for determining the clipping position of the signal to be recovered. In an alternative embodiment, the determining the clipping position of the signal to be recovered includes: performing an analog-to-digital (AD) sampling on the received signal to be recovered to convert the received signal into a digital time-domain signal; and determining the clipping position of the signal to be recovered using a polarity of the digital time-domain signal. Thus, the clipping position can be effectively determined.

In an alternative embodiment, the following manners may be used to determine the clipping position of the signal to be recovered according to the polarity of the time-domain signal: determining values of signals at corresponding symmetric positions of the digital time-domain signal; and determining the clipping position according to magnitudes of the values of the signals at the corresponding symmetric positions, wherein a position associated with a small value of the signal at the corresponding symmetric position corresponds to the clipping position.

After the clipping position is determined, the signal at the clipping position and the received signal to be recovered can be recovered so as to obtain the signal to be recovered which is as complete as possible. In an alternative embodiment, the recovering the signal to be recovered into the transmitted signal according to the determined clipping position, includes: recovering the signal at the clipping position using a counter cyclical symmetry of Asymmetrically Clipped-biased optical-OFDM (ACO-OFDM); converting the signal to be recovered in which the signal at the clipping position has been recovered into a frequency-domain signal using Fast Fourier Transform (FFT); and recovering the transmitted signal using the frequency-domain signal.

Embodiments of the present disclosure further provide a device for processing signal. The device is used to implement the above embodiments and preferable implementations. The descriptions which have been made with respect to the above embodiments will not be repeated here. As used below, the term “module” may realize combinations of software and/or hardware having predetermined functions. Although the devices as described below may be preferably realized in the form of software, hardware or the combination of software and hardware are also possible and may be devised.

FIG. 2 is a block diagram showing a structure of a device for processing signal according to some embodiments of the present disclosure. As shown in FIG. 2, the device includes a receiving module 22, a determination module 24 and a recovery module 26. Hereinafter, the explanations of the device are given.

The receiving module 22 is configured to receive a signal to be recovered. The determination module 24 is connected to the receiving module 22 and is configured to determine a clipping position of the signal to be recovered. The recovery module 26 is connected to the determination module 24, and is configured to recover the signal to be recovered into a transmitted signal according to the determined clipping position.

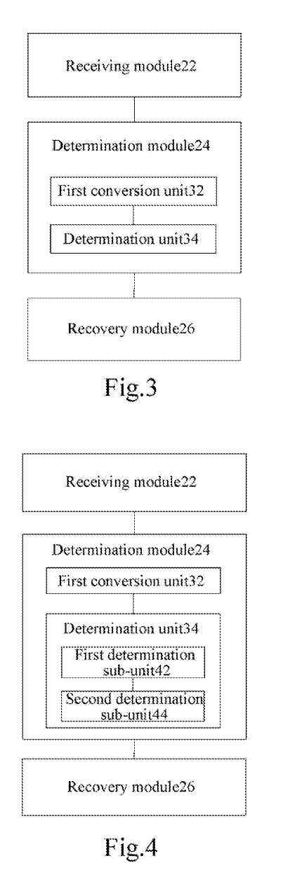

FIG. 3 is a block diagram showing a structure of the determination module 24 in the device for processing signal according to some embodiments of the present disclosure. As shown in FIG. 3, the determination module 24 includes a first conversion unit 32 and a determination unit 34. Next, the determination module 24 will be described.

The first conversion unit 32 is configured to perform an analog-to-digital (AD) sampling on the received signal to be recovered to convert the received signal into a digital time-domain signal. The determination unit 34 is connected to the first conversion unit 32, and is configured to determine the clipping position of the signal to be recovered using a polarity of the digital time-domain signal.

FIG. 4 is a block diagram showing a structure of the determination unit 34 in the device for processing signal according to some embodiments of the present disclosure. As shown in FIG. 4, the determination unit 34 includes a first determination sub-unit 42 and a second determination sub-unit 44. Next, the determination unit 34 will be described.

The first determination sub-unit 42 is configured to determine values of signals at corresponding symmetric positions of the digital time-domain signal. The second determination sub-unit 44 is connected to the first determination sub-unit 42, and is configured to determine the clipping position according to magnitudes of the values of the signals at the corresponding symmetric positions. A position associated with a small value of the signal at the corresponding symmetric position corresponds to the clipping position.

FIG. 5 is a block diagram showing a structure of the recovery module 26 in the device for processing signal according to some embodiments of the present disclosure. As shown in FIG. 5, the recovery module 26 includes a first recovery unit 52, a second conversion unit 54 and a second recovery unit 56. Next, the recovery module 26 will be described.

The first recovery unit 52 is configured to recover the signal at the clipping position using a counter cyclical symmetry of Asymmetrically Clipped-biased optical-OFDM (ACO-OFDM). The second conversion unit 54 is connected to the first recovery unit 52, and is configured to convert the signal to be recovered in which the signal at the clipping position has been recovered into a frequency-domain signal using Fast Fourier Transform (FFT). The second recovery unit 56 is connected to the second conversion unit 54, and is configured to recover the transmitted signal using the frequency-domain signal.

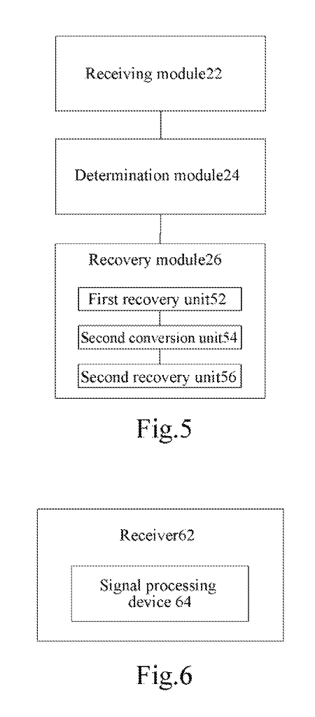

FIG. 6 is a block diagram showing a structure of a receiver according to some embodiments of the present disclosure. As shown in FIG. 6, the receiver 62 includes any one of the devices for processing signal 64 as described above.

Aiming at the problem of worse performance of the receiver in related art, the embodiments of the present disclosure further provide a system and method for realizing high-speed visible light communications based on enhanced ACO-OFDM. The following descriptions will be made with the example in which a signal sent by a transmitter is received. In the method, frame is used as a basic unit for data transmission in the physical layer. At the transmitting end, a baseband data sequence is generated using a digital method, and luminous intensity of LEDs is modulated using data to be transmitted so that the data is transmitted by the LEDs. At the receiving end, a light intensity signal (i.e., the above signal to be recovered) is detected directly using PD to convert the light intensity signal into an electrical signal. Then, a high-speed sampling and quantization are conducted to convert the electrical signal into a digital domain. The signal converted into the digital domain is demodulated by enhanced ACO-OFDM so as to recover or reproduce the transmitted signal.

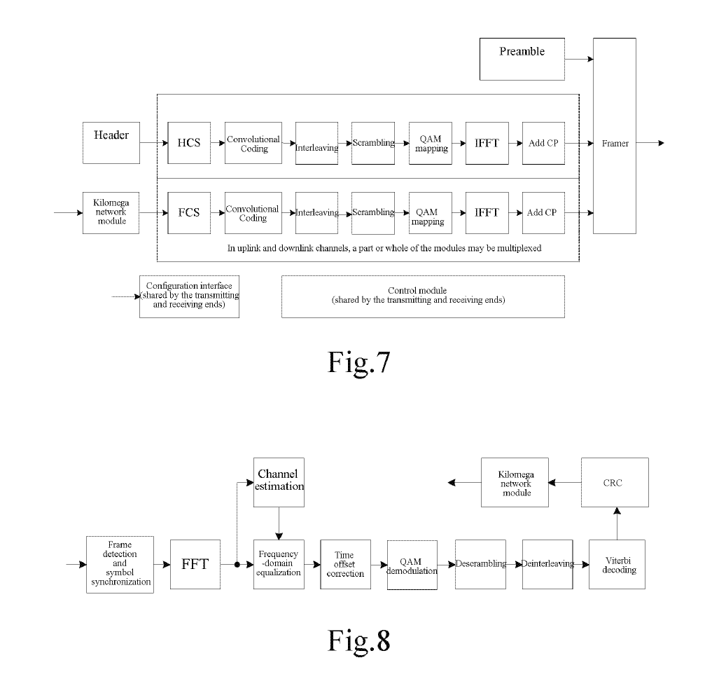

FIG. 7 is a block diagram showing a structure of a system transmitting end according to some embodiments of the present disclosure. The system transmitting end is equivalent to the above transmitter. As shown in FIG. 7, the transmitting end may include: a Cyclic Redundancy Check (CRC) checker, a channel encoder, an interleaver, a scrambler, a Quadrature Amplitude Modulation (QAM) modulator, an ACO-OFDM symbol generation and Inverse Fast Fourier Transform (IFFT) module, a framer, a LED driving circuit of transmitting end and transmitting LEDs, which are connected in order. FIG. 7 only shows a part of the block diagram, and the LED driving circuit at the transmitting end and the transmitting LEDs are not shown. In the figure, the HCS is equivalent to the CRC checker, and the convolutional coder is equivalent to the channel encoder. FIG. 8 is a block diagram showing a structure of a system receiving end according to some embodiments of the present disclosure. The system receiving end is equivalent to the above receiver. As shown in FIG. 8, the receiving end may include: a receiving Photo-Diode (PD), a PD driving circuit at the receiving end, a frame detection and symbol synchronization module, a Fast Fourier Transform (FFT) module, a frequency-domain equalizer, a time offset corrector, a Quadrature Amplitude Modulation (QAM) demodulator, a descrambler, a deinterleaver, a channel decoder, and a CRC checker, which are connected in order. FIG. 8 only shows a part of the block diagram, and the receiving PD and the PD driving circuit at the receiving end are not shown.

As shown in FIG. 7, the CRC checker adds a CRC check code into input data, and CRC check is performed at the receiving end to check the correctness of the received information. The channel encoder adds redundancy information into the input data to perform encoding so that the transmission reliability can be improved. The interleaver breaks the sequence of the encoded data to improve error correction capability of the receiving end. The scrambler converts the interleaved data into a random sequence to reduce long string of zeros (“0”) or long string of ones (“1”) in the data, thereby improving the weakness of high peak-to-average ratio in the OFDM system. The ACO-OFDM symbol generation and IFFT module conducts a Hermitian symmetry on the scrambled data and adds zeros on even-subcarriers to form ACO-OFDM symbols and conducts IFFT. The framer groups the output data flows from the channel encoder and adds a preamble, frame header information and so on into each group of data to form frames, so that the receiving end may receive the frames correctly and effectively. Frame is the basic unit of data transmission in the physical layer. The generated digital sequence is converted using a digital-to-analog (DA) method, and then is processed by the LED driving circuit at the transmitting end and sent to the air by the LEDs. The receiving end converts the light intensity signal back into current/voltage signal using the PDs, the analog-to-digital converter converts the signal into a digital time-domain signal, and samples, quantizes and encodes the signal. Algorithms such as frame detection, symbol synchronization and channel estimation, time offset correction are performed on the digital signal output from the analog-to-digital converter to recover the information bitstream in the frames. The bitstream is decoded by the channel decoder to obtain the output data.

The frame, as the basic unit for data transmission in the physical layer, includes a preamble, a frame header part and a data part. The preamble includes two pulse sequences: the first is the synchronization sequence (SS) which is directly sent in the time domain; and the second is the channel estimation sequence (SCH) which is formed by performing IFFT on the frequency-domain sequence SCHF and adding a Cyclic Prefix (CP).

The signal for driving the LEDs is generated using ACO-OFDM modulation. In the ACO-OFDM transmitter, first, the input serial data is converted into parallel data by serial-parallel conversion. Then, QAM constellation point mapping and modulation are performed to obtain complex-valued data blocks. Next, the modulated data is subject to the Hermitian symmetry and then is mapped onto odd-subcarriers, and zeros are placed on the even-subcarriers. For one frame, in the header and the frame body part, the preamble needs to be inserted into the OFDM symbol for time offset estimation. The symbols of the preambles inserted into individual preamble subcarriers are the same. Then, the ACO-OFDM symbols are subject to IFFT and CP is added. Finally, the negative signal in the obtained signals is clipped off, and the signals are subject to digital-to-analog (DA) conversion to modulate the luminous intensity of the LEDs.

The receiving end employs an enhanced ACO-OFDM receiver. In conventional ACO-OFDM receivers, the information on the even-subcarriers are discarded, and only the information on the odd-subcarriers is used to recover data. The enhanced ACO-OFDM receiver exploits the counter cyclic symmetry of the ACO-OFDM time-domain signal to recover the signal at the clipping position. This is equivalent of improving the performance of the receiver using the discarded information on the odd-subcarriers, while no changes are made to the transmitter. In the enhanced ACO-OFDM receiver, the PD converts the light intensity signal into an electrical signal, and then the signal is converted into a digital time-domain signal after AD sampling and quantization. After CP is removed from the received signal, the clipping position in the transmitted signal is determined according to the magnitudes of the values at symmetric positions of the digital time-domain signal. If the value is greater than zero, it is deemed that the value at a position corresponding to the transmitted signal is greater than zero; and if the value is smaller than zero, it is deemed that the position corresponds to the clipping position of the transmitted signal (due to the counter cyclic symmetry of the transmitted signal, the value is an opposite number of the value at the symmetric position thereof). After the clipped signal is recovered, the time-domain signal in which the clipped signal is recovered is transformed into the frequency domain via FFT. At this time, only the odd-subcarriers include information, while even-subcarriers all carry zeros (i.e., the recovery of the clipped signal is to transfer the information on the even-subcarriers onto the odd-subcarriers), and the odd-subcarriers are extracted as an estimation of the transmitted signal.

The digital detector conducts a series of processes on the digital signal output by the analog-to-digital converter, including frame detection, symbol synchronization and channel estimation, time offset correction and the like, so as to recover the information bitstream in the frames.

A correlation approach is used as the frame detection technology. The synchronization sequences used by the system include the sequences of -SS, SS, -SS. If there is an incoming frame, the correlation value is a negative value and becomes small quickly. If it is determined in successive detections that the correlation value is lower than a preset threshold value, it may be considered that a data frame is detected. After detection of a data frame, moving correlation is performed on the received signal, i.e., correlation with the local sequence SS, to calculate a correlation value, and a peak value is obtained within a certain window length, i.e., obtain a synchronization timing position. In order to counteract influences of the channels, after FFT is performed at the receiving end, a channel response is obtained in the frequency domain using channel estimation. The present disclosure uses the Least Square (LS) channel estimation approach. Then, frequency-domain equalization is conducted on the received signal. Sampling time offset of clock may cause phase rotation of signals on the subcarriers, and the phase offset caused by the time offset on the subcarriers is in direct proportion to the carrier number. The sampling time offset is estimated using the preamble signal inserted in each OFEM symbol at the transmitting end and is corrected. Then, the processed signal is descrambled, deinterleaved, and channel-decoded, and finally CRC is performed on the bit sequence after channel decoding. If the CRC is correct, it is determined that the parsed frame is correct; and if the CRC is wrong, it is determined that the receipt of the present frame is failed, and receipt of a new frame is started.

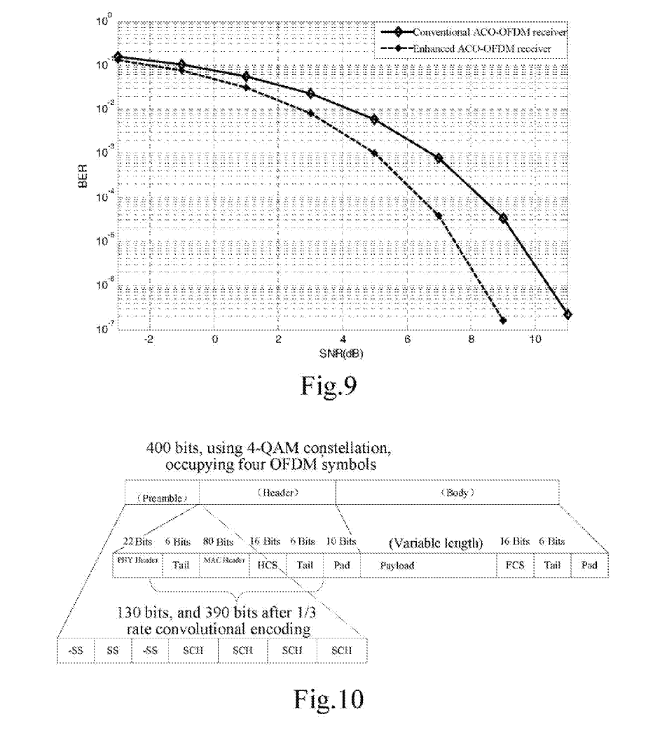

The above embodiment provides a novel ACO-OFDM receiver applicable in visible light wireless communications. By exploiting the counter symmetry in the time domain of the ACO-OFDM signal, the information at the clipping position of the transmitting end is recovered at the receiving end so as to reduce noise. As can be seen by analysis, this is equivalent to the utilization of the information on the even-subcarriers, and thus the power efficiency and the performance of the receiver can be improved. FIG. 9 is a graph showing BER simulation results of an enhanced ACO-OFDM according to some embodiments of the present disclosure. As shown in FIG. 9, under the condition that no changes are introduced to the transmitter, using the optimized receiver, the performance can be improved by 2 dB if BER=10⁻⁵. This is of great importance for development of ACO-OFDM technologies and improvements of short distance visible light wireless communication technologies.

The present disclosure will be described below with reference to specific embodiments.

In the embodiment, the system may realize high-speed point-to-point visible light communication (VLC) information transmission. The single-link maximum wireless transmission rate is over 120 Mbps, and the transmission distance is 1 to 3 meters. The basic clock frequency of the system is 491.52 MHz, and the sampling clock is 245.76 MHz. The basic parameters are shown in Table 1.

TABLE 1

| | |
|---|---|
| Parameters | Numerical values |

| | |
|---|---|
| subcarrier interval Δ_{F} | 0.96 MHz |
| IFFT/FFT period T_{FFT} = 1/Δ_{F} | 1.0417 us |
| number of subcarriers N_{S} | 256 |
| sampling clock B = N_{S} * Δ_{F} | 245.76 MHz |
| length of cyclic prefix T_{CP} | 0.13 us (=T_{FFT}/8, |
| | 16 sample values) |
| OFDM symbol length T_{SYM} = T_{FFT} + T_{CP} | 1.172 us |
| OFDM symbol rate R₀ = 1/T_{SYM} | 0.8533 M OFDM |
| | Symbols/s |
| number of subcarriers for transmitting data N_{SD} | 200 |
| number of subcarriers for transmitting | 50 |
| independent data N_{SD}_{_{—}}_{E} = N_{SD}/4 | |
| number of subcarriers for transmitting preamble | 24 |
| N_{SP} | |
| number of virtual subcarriers Nₙᵤₗₗ = N_{S} − N_{SD} − | 32 |
| N_{SP} | |
| average modulation factor MI (note 1) | 2.88 |
| number of encoded bits carried in each OFDM | 144 |
| symbol N_{CB} = N_{SD}_{_{—}}_{E} × MI | |
| encoded data rate R = R₀ × N_{CB} | 122.88 Mbps |

The average modulation factor is an average number of bits included in each symbol. The modulation factors of the Quadrature Phase Shift Keying (QPSK), hexadecimal Quadrature Amplitude Modulation (QAM) and 64-QAM are 2, 4 and 6, respectively. If the system uses bit loading, the average modulation factor is an average value of the modulation factors of individual subcarriers. The numbers of independent subcarriers when adopting 64-QAM, 16-QAM, and QPSK are 5, 12 and 37, respectively, from low frequency to high frequency, and the average modulation factor is 2.88.

In the system and method for realizing high-speed visible light communication based on enhanced ACO-OFDM proposed in the embodiments of the present disclosure, frame is used as the basic unit for data transmission in the physical layer. The frame structure in the physical layer of the system is as shown in FIG. 10. FIG. 10 is a schematic diagram showing a frame structure according to some embodiments of the present disclosure. One frame includes three parts: the preamble, the header and the body. At the transmitting end, a baseband data sequence is generated using a digital method, luminous intensity of LEDs is modulated using transmitted data so that the data is transmitted by the LEDs. At the receiving end, a light intensity signal is directly detected using PDs to convert the light intensity signal into an electrical signal. Then, high-speed sampling and quantization are conducted to convert the electrical signal into a digital time-domain signal. The converted digital time-domain signal is demodulated by enhanced ACO-OFDM to recover or reproduce the transmitted information, i.e., the above transmitted signal.

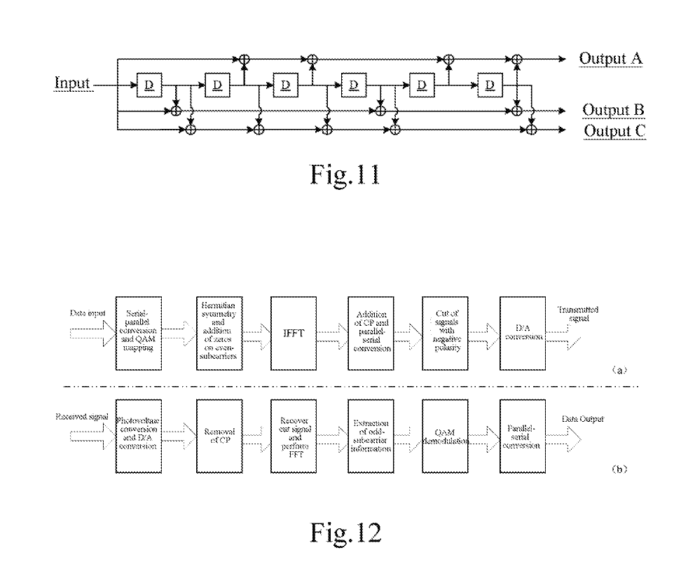

In the previously mentioned FIG. 7, the CRC checker adds a CRC check code into input data, and CRC check is performed at the receiving end to check the correctness of the received information. The check polynomial is x16+x12+x5+1. The channel encoder adds redundancy information into the input data to perform encoding so that the transmission reliability can be improved. The generator polynomials of the convolutional code are g0=(133)8, g1=(145)8, g2=(175)8. FIG. 11 is a schematic diagram showing a convolutional encoder according to some embodiments of the present disclosure. As shown in FIG. 11, the interleaver breaks the sequence of the encoded data to improve error correction capability of the receiving end, and performs a rectangular block interleaving on the output sequences of the convolutional encoder, the size of the interleaving block is 10×5, each point has 2 bits, and there are a total of 100 bits. The scrambler converts the interleaved data into a random sequence to reduce long string of zeros (“0”) or long string of ones (“1”) in the data, thereby improving the weakness of high peak-to-average ratio. The scramble code is a binary random sequence which is generated randomly, with a length equal to a length of one frame. The ACO-OFDM symbol generation and IFFT module conducts a Hermitian symmetry on the scrambled data and adds zeros on even-subcarriers to form ACO-OFDM symbols, and conducts IFFT. The framer groups the output data flows output from the channel encoder and adds a preamble, frame header information and so on into each group of data to form frames, so that the receiving end may receive the frames correctly and effectively. Frame is the basic unit of data transmission in the physical layer. The generated digital sequence is converted using a digital-to-analog (DA) method, and then is processed by the LED driving circuit at the transmitting end and sent to the air by the LEDs. The receiving end converts the light intensity signal into current/voltage signal using the PDs, the analog-to-digital converter converts the signal into a digital time-domain signal, and samples, quantizes and encodes the signal. Algorithms such as frame detection, symbol synchronization and channel estimation, and time offset correction are performed on the digital time-domain signal output from the analog-to-digital converter to recover the information bitstream in the frames. The bitstream is decoded by the channel decoder to obtain the output data.

The frame, as the basic unit for data transmission in the physical layer, includes a preamble, a frame header part and a data part, as shown in FIG. 10. The preamble includes two pulse sequences: the first is a synchronization sequence which is directly sent in the time domain, with a length of 127 sample values, as shown in Table 2.

TABLE 2

| Positions 1-8 | Positions 9-16 | Positions 17-24 | Positions 25-32 |
|---|---|---|---|
| N N N N N N | N P N P N P P N | N P P N N N P N | N N P N P P N P |
| N P | | | |
| Positions 33-40 | Positions 41-48 | Positions 49-56 | Positions 57-64 |
| N N P P P N | N N N N P N N P | N P N N P N N P | P N P P N P P P |
| N P | | | |
| Positions 65-72 | Positions 73-80 | Positions 81-88 | Positions 89-96 |
| N N N P P P | P N N N N N P P | N P N P N N N P | P N N P N P P P |
| P N | | | |
| Positions | | | |
| 97-104 | Positions 105-112 | Positions 113-120 | Positions 121-127 |
| N P P N N N | P P N P N P P P | P N N P P P P P | N P P P P P P |
| N P | | | |

In the above table, P represents a positive maximum value (which depends on a number of data bits; for example, if the number of data bits is 8, P represents (2̂8)−1); N represents a negative maximum value (which depends on a number of data bits; for example, if the number of data bits is 8, N represents −(2̂8)+1). -SS represents a sequence of opposite numbers of SS. The second portion is a channel estimation sequence (SCH), with a length of 144 sample values. The SCH is formed by performing IFFT on the frequency-domain sequence SCHF with a length of 128 sample values and adding Cyclic Prefixes (CPs) of 16 sample values. The values of the SCHF are as shown in Table 3.

TABLE 3

| Subcarrier | |
|---|---|
| number | data |
| 0 | 0 |
| 1 | −1 − j |
| 2 | +1 − j |
| 3 | −1 − j |
| 4 | −1 − j |
| 5 | +1 + j |
| 6 | +1 + j |
| 7 | −1 − j |
| 8 | −1 − j |
| 9 | −1 − j |
| 10 | +1 − j |
| 11 | +1 − j |
| 12 | −1 + j |
| 13 | +1 − j |
| 14 | +1 − j |
| 15 | −1 + j |
| 16 | −1 − j |
| 17 | +1 + j |
| 18 | +1 + j |
| 19 | +1 − j |
| 20 | +1 + j |
| 21 | +1 − j |
| 22 | +1 − j |
| 23 | −1 − j |
| 24 | −1 − j |
| 25 | +1 + j |
| 26 | −1 − j |
| 27 | +1 + j |
| 28 | −1 − j |
| 29 | +1 − j |
| 30 | −1 − j |
| 31 | +1 − j |
| 32 | −1 + j |
| 33 | −1 − j |
| 34 | −1 − j |
| 35 | −1 − j |
| 36 | +1 − j |
| 37 | −1 + j |
| 38 | −1 + j |
| 39 | +1 − j |
| 40 | +1 − j |
| 41 | −1 + j |
| 42 | +1 + j |
| 43 | +1 + j |
| 44 | +1 − j |
| 45 | +1 − j |
| 46 | +1 − j |
| 47 | −1 + j |
| 48 | −1 + j |
| 49 | +1 − j |
| 50 | −1 + j |
| 51 | −1 + j |
| 52 | −1 + j |
| 53 | +1 − j |
| 54 | +1 + j |
| 55 | +1 + j |
| 56 | −1 − j |
| 57 | 0 |
| 58 | 0 |
| 59 | 0 |
| 60 | 0 |
| 61 | 0 |
| 62 | 0 |
| 63 | 0 |

Table 3 shows the data transmitted by the odd-subcarriers No. 0-63, the odd-subcarrier No. 64 transmits zero, and the data transmitted by the odd-subcarriers No. 65-127 and the data transmitted by the odd-subcarriers No. 1-63 are conjugate-symmetric.

The signal for driving the LEDs is generated using ACO-OFDM modulation. In the ACO-OFDM transmitter, first, the input serial data is converted into parallel data by serial-parallel conversion. Then, QAM constellation point mapping and modulation (for detailed modulation approaches, refer to Table 1) are performed to obtain complex-valued data blocks. Next, the modulated data is subject to the Hermitian symmetry and then is mapped onto odd-subcarriers, and zeros are placed on the even-subcarriers. For one frame, in the header and the body parts, the preamble needs to be inserted into the OFDM symbols for time offset estimation. The preamble symbols inserted into individual preamble subcarriers are the same, i.e., P*(1+j), where P represents the positive maximum value. The subcarrier positions of the inserted preambles and the preamble symbols are shown in Table 4. The subcarrier number may start from zero, and only represents an odd-subcarrier. Then, the ACO-OFDM symbols are subject to IFFT and CP is added. Finally, the negative signal in the obtained signals is clipped off, and the signals are subject to digital-to-analog (DA) conversion to modulate the luminous intensity of the LEDs.

TABLE 4

Preamble positions

| | 8 | 16 | 24 | 32 | 40 | 48 |
|---|---|---|---|---|---|---|
| Preamble | 1 + j | 1 + j | 1 + j | 1 + j | 1 + j | 1 + j |
| symbols | | | | | | |

Preamble positions

| | 80 | 88 | 96 | 104 | 112 | 120 |
|---|---|---|---|---|---|---|
| Preamble | 1 − j | 1 − j | 1 − j | 1 − j | 1 − j | 1 − j |
| symbols | | | | | | |

The receiving end employs an enhanced ACO-OFDM receiver. In conventional ACO-OFDM receivers, the information on the even-subcarriers are discarded, and only the information on the odd-subcarriers is used to recover data. The enhanced ACO-OFDM receiver exploits the counter cyclic symmetry of the ACO-OFEM time-domain signal to recover the signal at the clipping position. FIG. 12 is a block diagram showing enhanced ACO-OFDM transmitter and receiver according to some embodiments of the present disclosure. Referring to FIG. 12, this is equivalent of improving the performance of the receiver using the information on the odd-subcarriers which have been discarded, while no changes are made to the transmitter. In the enhanced ACO-OFDM receiver, the PD converts the light intensity signal into electrical signal, and then the signal is converted into a digital time-domain signal after AD sampling and quantization. After CP is removed from the received signal, the clipping position in the transmitted signal is determined according to the magnitudes of the values at symmetric positions in the digital time-domain signal. If the value is greater than zero, it is deemed that the position corresponding to the value is a position where there is no clipped odd-subcarrier signal; and if the value at the symmetric position of the digital time domain is smaller than zero, it is deemed that the position corresponds to the clipping position of the transmitted signal (due to the counter cyclic symmetry of the transmitted signal, the value is an opposite number of the value at the symmetric position thereof). After the clipped signal is recovered, FFT is performed to convert the signal into the frequency domain. At this time, only the odd-subcarriers include information, and the odd-subcarriers are extracted as an estimation of the transmitted signal.

The digital detector conducts a series of processes on the digital signal output by the analog-to-digital converter, including frame detection, symbol synchronization and channel estimation, time offset correction and the like, so as to recover the information bitstream in the frames.

A correlation approach is used as the frame detection technology. The synchronization sequences used by the system include the sequences of -SS, SS, -SS. If there is an incoming frame, the correlation value is a negative value and becomes small quickly. If it is determined in successive detections that the correlation value is lower than a preset threshold value, it may be considered that a data frame is detected. After detection of a data frame, moving correlation is performed on the received signal, i.e., correlation with the local sequence SS, to calculate a correlation value, and a peak value is obtained within a certain window length to obtain a synchronization timing position. The channel estimation sequence at the transmitting end is as shown in Table 3. In order to counteract influences of the channels, after FFT is performed at the receiving end, a channel response is needed to be obtained in the frequency domain using channel estimation. The present disclosure uses the Least Square (LS) channel estimation approach. Then, frequency-domain equalization is conducted on the received signal. The sampling time offset of clock may cause phase rotation of signals on the subcarriers, and the phase offset caused by the time offset on the subcarriers is in direct proportion to the carrier number. The sampling time offset is estimated using the preamble signal inserted in each OFEM symbol at the transmitting end and is corrected. The processed signal is descrambled, deinterleaved, and channel-decoded, and finally CRC is performed on the bit sequence after channel decoding; if the CRC is correct, it may be determined that the parsed frame is correct; and if the CRC is wrong, it may be determined that the receipt of the present frame is failed, and then receipt of a new frame is started.

The analog front end uses an intensity-modulated/direct-detected (IM/DD) approach. The analog front end may be classified into a transmitting analog front end and a receiving analog front end. The transmitting analog front end uses Metal Oxide Semiconductor (MOS) transistors to drive LEDs to convert voltage signals from the Digital to Analog Converter (DAC) into optical signals and to send the optical signals to wireless optical channels. The receiving end converts the optical signals into current/voltage signals using PDs, and then delivers the signals to the Analog to Digital Converter (ADC) for subsequent processes.

The ACO-OFDM receiver in the embodiments of the present disclosure, by exploiting the counter cyclic symmetric structure of the transmitted signal, improves the performance. The receiver recovers the signal at the clipping position in the signal to be recovered to reduce noise. According to analysis, the recovery of the clipped noise is an equivalent of utilization of the information on even-subcarriers in the receiver, and thus the power utilization ratio can be improved. According to the simulation results, the performance of the receiver can be improved by 2 dB if BER=10⁻⁵, and no changes are introduced into existing transmitters. This can greatly improve the performance of the receiver, and at the same time, the solutions in the above embodiments can also improve the performance of the transmitter.

It is apparent to those skilled in this art that individual modules or steps of the present disclosure as described above may be implemented using general purpose computing devices, which can be integrated in a single computing apparatus, or distributed over a network consisting of a plurality of computing devices. Alternatively, the modules or steps may be implemented using program codes which are executable by the computing device, so that the codes may be stored in a storage device for execution by the computing device. Under some situations, the shown or described steps may be performed in an order different from that described herein, or the modules or steps can be implemented as integrated circuit modules, or a plurality of modules or steps among the modules or steps of the present disclosure may be implemented as a single integrated circuit module. The present disclosure is not limited to any particular combination of hardware and software.

The above-described are exemplary embodiments of the present disclosure only, and not for limiting the present disclosure. For those skilled in this art, many modifications and changes may be made to the present disclosure, and any modification, equivalent substitution, improvement and so on without departing from the spirit and principle of the present disclosure fall within the scope as claimed by the present disclosure.

### INDUSTRIAL APPLICABILITY

As described above, the embodiments of the present disclosure provide a method for processing signal and a device thereof, and a receiver. The present disclosure has the following advantageous effects: the present disclosure can address the problem of worse performance of the receiver in the related art, and thereby improving the performance of the receiver.

1. A method for processing signal, comprising:
receiving a signal to be recovered;
determining a clipping position of the signal to be recovered; and
recovering the signal to be recovered into a transmitted signal according to the determined clipping position.

2. The method according to claim 1, wherein the determining the clipping position of the signal to be recovered comprises:
performing an analog-to-digital AD sampling on the received signal to be recovered to convert the received signal to be recovered into a digital time-domain signal; and
determining the clipping position of the signal to be recovered according to a polarity of the digital time-domain signal.

3. The method according to claim 2, wherein the determining the clipping position of the signal to be recovered according to the polarity of the digital time-domain signal comprises:
determining values of signals at corresponding symmetric positions of the digital time-domain signal; and
determining the clipping position according to magnitudes of the values of the signals at the corresponding symmetric positions, wherein a position associated with a small value of the signal at the corresponding symmetric position corresponds to the clipping position.

4. The method according to claim 2, wherein the recovering the signal to be recovered into the transmitted signal according to the determined clipping position comprises:
recovering a signal at the clipping position according to a counter cyclical symmetry of Asymmetrically Clipped-biased Optical-Orthogonal Frequency Division Multiplexing ACO-OFDM;
converting the signal to be recovered in which the signal at the clipping position has been recovered into a frequency-domain signal using Fast Fourier Transform FFT; and
recovering the transmitted signal using the frequency-domain signal.

5. A device for processing signal, comprising:
a processor; and
a memory for storing instructions executable by the processor;
wherein the processor is configured to:
receive a signal to be recovered;
determine a clipping position of the signal to be recovered; and
recover the signal to be recovered into a transmitted signal according to the determined clipping position.

6. The device according to claim 5, wherein the processor is configured to:
perform an analog-to-digital AD sampling on the received signal to be recovered to convert the received signal into a digital time-domain signal; and
determine the clipping position of the signal to be recovered using a polarity of the digital time-domain signal.

7. The device according to claim 6, wherein the processor is configured to:
determine values of signals at corresponding symmetric positions of the digital time-domain signal; and
determine the clipping position according to magnitudes of the values of the signals at the corresponding symmetric positions, wherein a position associated with a small value of the signal at the corresponding symmetric position corresponds to the clipping position.

8. The device according to claim 5, wherein the processor is configured to:
recover a signal at the clipping position using a counter cyclical symmetry of Asymmetrically Clipped-biased Optical-Orthogonal Frequency Division Multiplexing ACO-OFDM;
convert the signal to be recovered in which the signal at the clipping position has been recovered into a frequency-domain signal using Fast Fourier Transform FFT; and
recover the transmitted signal using the frequency-domain signal.

9. A computer storage medium, wherein the computer storage medium is stored with computer-executable instructions, and the computer-executable instructions are configured to:
receive a signal to be recovered;
determine a cutting position of the signal to be recovered; and
recover the signal to be recovered into a transmitted signal according to the determined clipping position.
